(19) United States
(12) Patent Application Publication
(10) Pub. No.: US 2022/0214628 A1
(43) Pub. Date: Jul. 7, 2022

(54) ELECTROPHOTOGRAPHIC PHOTORECEPTOR CAPABLE OF SUPPRESSING MICRO-JITTER IMAGE DEFECT

(71) Applicant: Hewlett- Packard Development Company, L.P., Spring, TX (US)

(72) Inventors: HwanKoo Lee, Suwon-si (KR); Hyeji SONG, Suwon-si (KR)

(73) Assignee: Hewlett- Packard Development Company, L.P., Spring, TX (US)

(21) Appl. No.: 17/608,175

(22) PCT Filed: Mar. 18, 2020
(86) PCT No.: PCT/US2020/023267

§ 371 Date: Nov. 2, 2021

(30) Foreign Application Priority Data
Oct. 28, 2019 (KR) 10-2019-0134605

(51) Int. Cl. G03G 5/047; G03G 5/14; G03G 15/00

(52) U.S. Cl. CPC G03G 5/047; G03G 15/75; G03G 5/144

(57) ABSTRACT

An electrophotographic photoreceptor includes an electrically conductive substrate, and a laminate-type photosensitive layer formed on the electrically conductive substrate. An allowable range of a charging voltage Vx to be applied to the electrophotographic photoreceptor by a charging device is V₀−150≤Vₓ≤V₀+150, and an electrostatic capacitance per unit area of the electrophotographic photoreceptor is 90 pF/cm² or more. VO is an initial charging voltage applied to the electrophotographic photoreceptor. Also, an image forming apparatus and an image forming cartridge can be provided with the electrophotographic photoreceptor.

### BACKGROUND

Electrophotographic devices such as laser printers, copying machines, and facsimile machines include an electrophotographic photoreceptor (hereinafter, also referred to simply as a ‘photoreceptor’) including a photosensitive layer formed on an electrically conductive substrate. The electrophotographic photoreceptor may be in the form of a plate, a belt, a drum, or the like, and forms an image as follows. First, a surface of the photosensitive layer is uniformly and electrostatically charged, and then the charged surface is exposed to a pattern of light, thus forming an image. The light exposure selectively dissipates the charge in the exposed regions where the light strikes the surface, thereby forming a pattern of charged and uncharged regions, which is referred to as a latent image. Then, the latent image is developed by using a toner to form a toner image on the surface of the photosensitive layer. The resulting toner image may be transferred to a suitable final or intermediate receiving surface, such as paper, or the photosensitive layer may function as the final receptor for receiving the image.

### BRIEF DESCRIPTION OF THE DRAWINGS

FIG. 1 is a schematic view illustrating an example of an electrophotographic image forming apparatus and an electrophotographic cartridge including an electrophotographic photoreceptor according to an example of the disclosure;

FIG. 2 is a schematic diagram of an in-house jig for measuring electrostatic capacitance of a photoreceptor drum;

FIG. 3 is a schematic circuit diagram for measuring current and charging potential for measuring electrostatic capacitance of a photoreceptor drum;

FIG. 4 shows photographs showing a case in which a micro-jitter problem occurs when a halftone image is printed;

FIG. 5 shows photographs of a case in which a micro-jitter problem does not occur when a halftone image is printed; and

FIG. 6 is a graph showing results of plotting electrostatic capacitance values and charging margin values ΔV₀ of photoreceptor drums obtained in Examples 1 to 10, Comparative Examples 1 to 5, and Reference Examples 1 to 3 to the Y-axis and the X-axis, respectively.

### DETAILED DESCRIPTION

Hereinafter, a laminate type electrophotographic photoreceptor according to an example of the disclosure, and an electrophotographic cartridge and an electrophotographic image forming apparatus each using the electrophotographic photoreceptor will be described in detail. Hereinafter, a negative-charging type laminate electrophotographic photoreceptor will be described, but the disclosure is not limited thereto.

A corona charging method or a contact charging method has been used as a charging method of electrophotographic photoreceptors. Recently, a contact charging method has been used. In this method, an inexpensive conductive elastic roller, for example, a conductive rubber roller (hereinafter, also referred to simply as ‘rubber roller’) is used as a charging member for charging a photoreceptor in low speed printers and black and white printers. According to the contact charging method, a direct current (DC) charging method by which DC voltage is applied and an alternate current (AC)/DC charging method by which AC voltage superimposed on DC voltage is applied are used. Although the DC charging method is more economical than the AC/DC charging method, micro-jitter image defects occur more easily by the DC charging method. The micro-jitter problem is generally caused by a non-uniform charging voltage applied to the photoreceptor during a charging process. When the AC/DC charging method or the corona charging method, which is a non-contact type charging method, is used, the micro-jitter problem may be easily solved. However, because the corona charging method is more expensive, causes an ozone generation problem, and additionally uses a cleaning device to prevent contamination, it is difficult to apply the corona charging method to a small-size or low-cost developing system. The AC/DC charging method may further deteriorate lifetime of the photoreceptor in contact with the rubber roller charging member as well as use excessive electrical energy.

As described above, the micro-jitter problem is caused because a charging voltage is not uniform on the photoreceptor during the charging process. The micro-jitter problem involves characteristics of the charging member, such as the rubber roller, and the photoreceptor involved in charging. When the rubber roller is used, non-uniformity in the amount of electric charge applied to the photoreceptor occurs in an image forming apparatus using a DC charging method. This is because a desired amount of electric charge is not applied in an entry stage in which charging is initiated between the photoreceptor drum and the rubber roller and a discharge occurs in an escape stage in which the charging is terminated between the photoreceptor drum and the rubber roller.

Although improvement of charging capability of the charging member is one method for solving the micro-jitter problem, the solution of the micro-jitter problem occurring during DC charging is focused on the photoreceptor according to the disclosure. For example, the micro-jitter problem occurring during DC charging is solved or prevented by facilitating charging of the photoreceptor with a desired amount of electric charge in the entry stage of charging by controlling the electrostatic capacitance, which is one of the electrical properties of the photoreceptor that is a factor affecting the micro-jitter.

The photoreceptor according to the disclosure has a laminate type electrophotographic photoreceptor structure in which an undercoat layer, a charge generation layer, and a charge transport layer are sequentially formed on an electrically conductive substrate.

The electrically conductive substrate may be in the form of a plate, disc, sheet, belt, drum, or the like which may include any conductive material, for example, a metal or an electrically conductive polymer. The metal may be aluminum or an aluminum-based alloy, vanadium, nickel, copper, zinc, palladium, indium, tin, platinum, stainless steel, chromium, or the like. The electrically conductive polymer may be a polyester resin, a polycarbonate resin, a polyamide resin, a polyimide resin, and any mixture thereof, or a copolymer of monomers used in preparing the resins described above in which an electrically conductive material such as a conductive carbon, tin oxide, indium oxide, or the like is dispersed. An organic polymer sheet or glass sheet on which a metal is deposited or a metal sheet is laminated may be used as the electrically conductive substrate.

The undercoat layer may be formed between the electrically conductive substrate and the charge generation layer, as described below, with excellent adhesiveness.

The undercoat layer plays a role, such as improvement of image quality, improvement of adhesion between the electrically conductive substrate and the photosensitive layer, and prevention of dielectric breakdown of the photosensitive layer by preventing charge injection to the photosensitive layer from the electrically conductive substrate. The undercoat layer may be formed, but not limited thereto, by dispersing a conductive powder such as carbon black, graphite, metal powder, or a metal oxide powder such as indium oxide, tin oxide, indium tin oxide, or titanium oxide in an insulating binder resin such as casein, polyvinyl alcohol, a polyamide, a polyimide, ethyl cellulose, gelatin, a phenolic resin, a melamine resin, or the like; or a conductive binder resin such as a polythiophene, a polypyrrole, and a polyaniline. The undercoat layer may also be formed of an inorganic layer, for example, anodic aluminum oxide, aluminum oxide, and aluminum hydroxide. A decrease in the electrical resistance of the laminate type electrophotographic photoreceptor by adding metal oxide particles to the undercoat layer may help to reduce non-uniformity of charging. However, this may decrease the lifetime of the electrophotographic photoreceptor and also, a charge leakage may occur in a high-temperature, high-humidity (HH) environment. Therefore, an added amount of the metal oxide particles is determined in consideration of the foregoing two factors. A thickness of the undercoat layer may be in a range of about 0.05 μm to about 10 μm, for example, about 0.1 μm to about 8 μm, about 0.5 μm to about 8 μm, about 1 μm to about 8 μm, about 1 μm to about 7 μm, about 1.1 μm to about 5 μm, about 1.2 μm to about 5 μm, about 1.5 μm to about 5 μm, about 1.7 μm to about 2.5 μm, and about 1.8 μm to about 2.3 μm.

The charge generation layer and the charge transport layer are sequentially formed as photosensitive layers on the undercoat layer.

The charge generation layer has a configuration in which a charge generating material is dispersed and/or dissolved in a binder resin.

Examples of a usable charge generating material may be organic materials, such as a phthalocyanine-based compound, an azo-based compound, a bisazo-based compound, a triazo-based compound, a quinone-based pigment, a perylene-based compound, an indigo-based compound, a bisbenzoimidazole-based pigment, an anthraquinone-based compound, a quinacridone-based compound, an azulenium-based compound, a squarylium-based compound, a pyrylium-based compound, a triarylmethane-based compound, a cyanine-based compound, a perynone-based compound, a polycycloquinone-based compound, a pyrrolopyrrole-based compound, or a naphthalocyanine-based compound; and inorganic materials, such as amorphous silicon, amorphous selenium, rhombohedral selenium, tellurium, a selenium-tellurium alloy, cadmium sulfide, antimony sulfide, or zinc sulfide. However, the charge generating material that may be used in the photosensitive layer is not limited thereto, and the charge generating materials may be used alone or in combination of two or more thereof.

The charge generating material in the disclosure may be a phthalocyanine-based compound. According to an example of the disclosure, the phthalocyanine-based compound is not limited so long as it satisfies Chemical Formula 1 or 2. The phthalocyanine-based compound may be a metal-free phthalocyanine-based compound represented by the following Chemical Formula 1, or a metal phthalocyanine-based compound represented by the following Chemical Formula 2, or a mixture thereof.

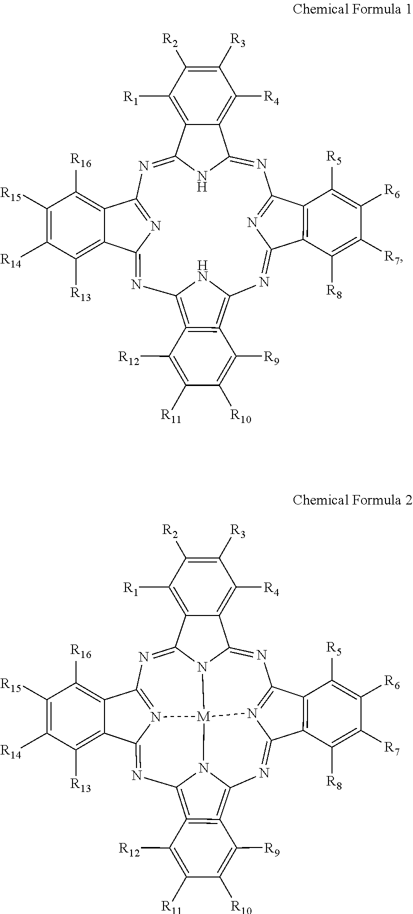

In Chemical Formula 1 and 2, R₁ to R₁₆ each independently represent a hydrogen atom, a halogen atom, a nitro group, an alkyl group with a carbon number of about 1 to 20, for example, a carbon number of about 1 to 7, or an alkoxy group with a carbon number of about 1 to 20, for example, a carbon number of about 1 to 7, and M is Cu, Fe, Mg, Sn, Pb, Zn, Co, Ni, Mo, or halogenated aluminum; or Ti, V, Zr, Ge, Ga, Sn, Si or In with an oxygen atom, halogen atom, or hydroxy group bonded thereto. The alkyl group or alkoxy group may be substituted with an appropriate substituent. Examples of the phthalocyanine-based compound may be a metal-free phthalocyanine, titanyl phthalocyanine, oxo-titanyl phthalocyanine, oxo-vanadyl phthalocyanine, copper phthalocyanine, aluminum chloride phthalocyanine, gallium chloride phthalocyanine, indium chloride phthalocyanine, germanium dichloride phthalocyanine, hydroxy aluminum phthalocyanine, hydroxy gallium phthalocyanine, hydroxy indium phthalocyanine, dihydroxy germanium phthalocyanine, tin phthalocyanine, tin oxide phthalocyanine, derivatives thereof, or any combinations thereof. Examples of the phthalocyanine-based compound may be an oxo-titanyl phthalocyanine pigment, such as d-type or y-type oxo-titanyl phthalocyanine having the strongest diffraction peak at a Bragg angle of about 27.1° (28±0.2°), a β-type oxo-titanyl phthalocyanine having the strongest diffraction peak at a Bragg angle of about 26.1° (28±0.2°), an α-type oxo-titanyl phthalocyanine having the strongest diffraction peak at a Bragg angle of about 7.5° (28±0.2°) in a powder X-ray diffraction peak; or a metal-free phthalocyanine pigment, such as X-type metal-free phthalocyanine or tau-type metal-free phthalocyanine having the strongest diffraction peak at Bragg angles of about 7.5° and about 9.2° (28±0.2°) in a powder X-ray diffraction peak. These phthalocyanine-based pigments may be effectively used in the disclosure because the phthalocyanine-based pigments have the best sensitivity to light having a wavelength range of about 780 nm to about 800 nm and the sensitivities may be selected according to crystal structures thereof.

The phthalocyanine-based compound of Chemical Formula 1 or 2 used in the disclosure may be easily synthesized by a method described in F. H. Moser, A. L. Thomas, “Phthalocyanine Compounds”, 1963, the disclosure of which is incorporated by reference herein in its entirety.

In the charge generation layer, the charge generating material is dispersed and/or dissolved in the binder resin. Examples of a usable binder resin may be polyvinyl butyral, polyvinyl acetal, polyvinyl acetate, a polyester, a polyamide, polyvinyl alcohol, polyvinyl chloride, a polyurethane, a polycarbonate, a polymethacrylate, polyvinylidene chloride, polystyrene, a styrene-butadiene copolymer, a styrene-methyl methacrylate copolymer, a vinylidene chloride-acrylonitrile copolymer, a vinyl chloride-vinyl acetate copolymer, a vinyl chloride-vinyl acetate-maleic anhydride copolymer, an ethylene-acrylic acid copolymer, an ethylene-vinyl acetate copolymer, a formal resin, a cellulose-based resin such as methyl cellulose, ethyl cellulose, nitrocellulose, or carboxymethyl cellulose, a silicone resin, a silicone-alkyd resin, a phenol-formaldehyde resin, a cresol-formaldehyde resin, a phenoxy resin, a styrene-alkyd resin, a poly-N-vinycarbazole resin, polyvinylformal, polyhydroxystyrene, polycycloolefin, polyvinylpyrrolidone, poly(2-ethyl-oxazoline), polysulfone, a melamine resin, a urea resin, an amino resin, an isocyanate resin, an epoxy resin, an acrylic resin, and a copolymer of monomers thereof. These binder resins may be used alone or in combination of two or more.

A weight ratio of the charge generating material to the binder resin may be in a range of about 1:0.3 to about 1:4 and for example, may be in a range of about 1:0.5 to about 1:3 or about 1:0.5 to about 1:2. When the weight ratio of the binder resin is less than about 0.3, stability of a coating slurry for forming a charge generation layer may decrease due to insufficient dispersion of the charge generating material, thus a uniform charge generation layer may be difficult to obtain during coating on the electrically conductive substrate, and adhesion may also decrease. When the weight ratio of the binder resin is greater than about 4, charge potential may not be maintained and a desired image quality may not be obtained due to insufficient sensitivity caused by a large amount of the binder resin.

A solvent used in preparation of the coating slurry for forming the charging generation layer may vary according to a type of the used binder resin, and a solvent may be selected which does not affect the undercoat layer during coating of the charge generation layer. Examples of the solvent may be methyl isopropyl ketone, methyl isobutyl ketone, 4-methoxy-4-methyl-2-pentanone, isopropyl acetate, t-butyl acetate, isopropyl alcohol, isobutyl alcohol, acetone, methyl ethyl ketone, cyclohexanone, 1,2-dichloroethane, 1,1,2-trichloroethane, 1,1,1-trichloroethane, trichloroethylene, tetrachloroethane, dichloromethane, tetrahydrofuran, dioxane, dioxolane, methanol, ethanol, 1-propanol, 1-butanol, 2-butanol, 1-methoxy-2-propanol, ethyl acetate, butyl acetate, dimethyl sulfoxide, methylcellosolve, butyl amine, diethyl amine, ethylene diamine, isopropanol amine, triethanol amine, triethylene diamine, N,N′-dimethyl formamide, 1,2-dimethoxyethane, benzene, toluene, xylene, methylbenzene, ethylbenzene, cyclohexane, anisole, etc. These solvents may be used alone or in combination of two or more.

Next, a method of forming a charge generation layer is described. First, about 100 parts by weight of a charge generating material including a phthalocyanine pigment such as oxo-titanyl phthalocyanine and about 30 to 400 parts by weight, for example, about 50 to 200 parts by weight, of a binder resin are mixed. A solvent is mixed to the foregoing mixture so as to obtain a solid content range of about 1 wt % to 8 wt %, for example, about 1 wt % to 5 wt %. Glass beads, steel beads, zirconia beads, alumina beads, zirconia balls, alumina balls, or steel balls are added to the mixture and the mixture is dispersed for about 2 hours to about 50 hours. At this time, a grinding or milling method may be used as a dispersion method. Examples of a usable dispersion apparatus may be an attritor, a ball mill, a sand mill, a Banburry mixer, a roll mill, a three-roll mill, a nanomiser, a microfluidizer, a stamp mill, a planetary mill, a vibration mill, a kneader, a homonizer, a Dyno-Mill, a micronizer, a paint shaker, a high-speed mixer, an ultimiser, an ultrasonicator, etc. These milling apparatuses may be used alone or in combination of two or more. The coating slurry for forming a charge generation layer may further include an additive. The additives, such as a dispersant, a photostabilizer, an antioxidant, an antifoaming agent, a surfactant, and a plasticizer, may be used alone or appropriately used in combination.

The coating slurry for forming a charge generation layer thus prepared is coated on the undercoat layer. Examples of a coating method may be a dip coating method, a ring coating method, a roll coating method, or a spray coating method. A charge generation layer may be formed by drying the substrate thus coated in a temperature range of about 90° C. to about 200° C. for about 0.1 hours to about 2 hours.

A thickness of the charge generation layer may be in a range of about 0.005 μm to about 5 μm, for example, about 0.05 μm to about 5 μm or about 0.1 μm to about 2 μm. When the thickness of the charge generation layer is less than about 0.005 μm, the charge generation layer may not be uniformly formed, and when the thickness of the charge generation layer is greater than about 5 μm, electrical characteristics tend to be degraded.

A charge transport layer including a charging transporting material and a binder resin is formed on the charge generation layer. The charge transporting material functions to form an electrostatic latent image by transferring holes generated from the charge generation layer to a surface of the charge transport layer through a conductive path formed in the charge transport layer by light exposure. The charge transporting material includes a hole transporting material transporting holes and an electron transporting material transporting electrons. When the laminate type photoreceptor is used as a negatively charged type, the hole transporting material is used as a major component of the charge transporting material. In this case, a small amount of the electron transporting material may be added thereto in order to prevent a hole trap. A content of the electron transporting material is in a range of about 0 to 50 parts by weight, for example, about 5 to 30 parts by weight.

Examples of the hole transporting material which may be included in the charge transport layer may be nitrogen containing cyclic compounds or condensed polycyclic compounds such as a hydrazone-based compound, a butadiene-based compound, a benzidine-based compound, a stilbene-based compound, a bisazo-based compound, a pyrene-based compound, a carbazole-based compound, an arylmethane-based compound, a thiazol-based compound, a styryl-based compound, a pyrazoline-based compound, an arylamine-based compound such as a diphenylamine-based compound and triphenylamine-based compound, an oxazole-based compound, an oxadiazole-based compound, a pyrazoline-based compound, a pyrazolone-based compound, a polyaryl alkane-based compound, a polyvinylcarbazole-based compound, a N-acrylamide methylcarbazole copolymer, a triphenylmethane copolymer, a styrene copolymer, polyacenaphthene, polyindene, a copolymer of acenaphthylene and styrene, and a formaldehyde-based condensed resin. Also, a high molecular weight compound having substituents of the above compounds in a main chain or a side chain may be used. The foregoing hole transporting materials may be used alone or in combination of two or more.

When the electron transporting material is included in the charge transporting material, a usable electron transporting material is not limited and any electron transporting material may be included. Examples of the electron transporting material may be electron transporting low molecular weight compounds such as a benzoquinone-based compound, a naphthoquinone-based compound, an anthraquinone-based compound, a malononitrile-based compound, a diphenoquinone-based compound, a fluorenone-based compound, a cyanoethylene-based compound, a cyanoquinodimethane-based compound, a xanthone-based compound, a phenanthraquinone-based compound, a phthalic anhydride-based compound, a thiopyran-based compound, a dicyanofluorenone-based compound, a naphthalenetetracarboxylic acid diimide compound, a benzoquinoneimine-based compound, a stilbenequinone-based compound, a diiminoquinone-based compound, a dioxotetracenedione compound, and a pyran sulfide-based compound. In addition, an electron transporting polymer compound or a pigment having n-type semiconductor characteristics may be used. The foregoing electron transporting materials may be used alone or in combination of two or more.

Examples of the hole transporting material may be 1,1-bis-(para-diethylaminophenyl)-4,4-diphenyl-1,3-butadiene, N,N′-bis(ortho,para-dimethylphenyl)-N,N′-diphenylbenzidine, 3,3′-dimethyl-N,N,N′,N′-tetrakis-4-methylphenyl-(1,1′-biphenyl)-4,4′-diamine, N-ethyl-3-carbozolylaldehyde-N,N′-diphenylhydrazone, 4-(N, N-bis(para-toluyl)amino)-betaphenylstilbene, N,N,N′,N′-tetrakis(3-methylphenyl)-1,3-diaminobenzene, N,N-diethylaminobenzaldehydediphenyl-hydrazone, N,N-dimethylaminobenzaldehydediphenyl-hydrazone, 4-dibenzylamino-2-methylbenzaldehydediphenylhydrazone, 2,5-bis(4-aminophenyl)-[1,3,4]oxadiazole, (2-phenylbenzo[5,6-b]-4H-thiopyran-4-ylidene)-propanedinitrile-1,1-dioxide, 4-bromo-triphenylamine, 4,4′-(1,2-ethanediylidene)-bis(2,6-dimethyl-2,5-cyclohexadiene-1-one), 3,4,5-triphenyl-1,2,4-triazole, 2-(4-methylphenyl)-6-phenyl-4H-thiopyran-4-ylidene-propanedinitrile-1,1-dioxide, 4-dimethylamino-benzaldehyde-N, N-diphenylhydrazone, 9-ethylcarbazole-3-aldehyde-N-methyl-N-phenylhydrazone, 5-(2-chlorophenyl)3-[2-(2-chlorophenyl)ethenyl]-1-phenyl-4,5-dihydro-1H-pyrazole, 4-diethylamino-benzaldehyde-N,N-diphenylhydrazone, N-biphenylyl-N-phenyl-N-(3-methylphenyl)amine, 9-ethylcarbazole-3-aldehyde-N, N-diphenylhydrazone, 3,5-bis(4-tert-butylphenyl)4-phenyltriazole, 3-(4-biphenylyl)-4-phenyl-5-tert-butylphenyl-1,2,4-triazole, 4-diphenylamino-benzaldehyde-N, N-diphenylhydrazone, 5-(4-diethylaminophenyl)-3-[2-(4-diethylaminophenyl)-ethenyl]-1-phenyl-4,5-dihy dro-1-pyrazole, N,N′-di(4-methylphenyl)-N,N′-diphenyl-1,4-phenylenediamine, 4-dibenzylaminobenzaldehyde-N, N-diphenylhydrazone, 4-dibenzylamino-3-methylbenzaldehyde-N, N-diphenylhydrazone, 4,4′-bis(carbazole-9-yl)biphenyl, N,N,N′,N′-tetraphenylbenzidine, N,N′-bis(4-methylphenyl)-N,N′-bis(phenyl)-benzidine, N,N′-bis(3-methylphenyl)-N,N′-bis(phenyl)benzidine, N,N,N′,N′-tetrakis(4-methylphenyl)bezidine, N,N,N′,N′-tetrakis(3-methylphenyl)bezidine, di(4-dibenzylaminophenyl)ether, N,N′-di(naphthalene-2-yl)-N,N′-diphenylbezidine, N,N′-di(naphthalene-1-yl)-N,N′-diphenylbezidine, 1,3-bis(4(4-diphenylamino)phenyl-1,3,4-oxadiazole-2-yl)benzene, N,N′-di(naphthalene-2-yl)N,N′-di(3-methylphenyl)bezidine, N,N′-di(naphthalene-1-yl)-N,N′-di(4-methylphenyl)bezidine, N,N′-di(naphthalene-2-yl)-N,N′-di(3-methylphenyl)bezidine, 1,1-bis(4-bis(4-methylphenyl)aminophenyl)cyclohexane, 4,4′,4″-tris(carbazole-9-yl)-triphenylamine, 4,4′,4″-tris(N,N-diphenylamino)-triphenylamine, N,N′-bis(biphenyl-1-yl)-N,N′-bis(naphth-1-yl)benzidine, 4,4′,4″-tris(N-3-methylphenyl-N-phenylamino)triphenylamine, N,N,N′,N′-tetrakis(biphenyl-4-yl)benzidine, 4,4′,4″-tris(N-(1-naphthyl)-N-phenylamino)triphenylamine, and 4,4′,4″-tris(N-(2-naphthyl)-N-phenylamino)triphenylamine. These hole transporting materials may be used alone or in combination of two or more.

If the charge transporting material itself has film-forming characteristics, the charge transporting layer may be formed without the binder resin, but usually low molecular materials do not have film-forming characteristics. Therefore, the charge transporting material is dissolved or dispersed with a binder resin in a solvent to prepare a coating composition (solution or dispersion) for forming a charge transport layer, and then the solution or the dispersion is coated on the charge generation layer and dried to form the charge transport layer. Examples of the binder resin which may be used for the charge transport layer of the electrophotographic photoreceptor of the disclosure include, but are not limited to, an insulation resin capable of forming a film, such as polyvinyl butyral, a polyarylate (a condensed polymer of bisphenol A and phthalic acid, and so on), a polycarbonate, a polysulfone, a polyester resin, a phenoxy resin, polyvinyl acetate, an acrylic resin, a polyacrylamide resin, a polyamide, polyvinyl pyridine, a cellulose-based resin, a urethane resin, an epoxy resin, a silicone resin, polystyrene, a polyketone, polyvinyl chloride, a vinyl chloride-vinyliacetate copolymer, polyvinyl acetal, polyacrylonitrile, a phenolic resin, a melamine resin, casein, polyvinyl alcohol, and polyvinyl pyrrolidone; and an organic photoconductive polymer, such as poly N-vinyl carbazole, polyvinyl anthracene, polyvinyl pyrene, and so on. For example, a polycarbonate resin may be used as the binder resin for a charge transport layer and among the polycarbonate resin, polycarbonate-A derived from bisphenol A or polycarbonate-C derived from methylbisphenol-A, and polycarbonate-Z derived from cyclohexylidene bisphenol may be used. Polycarbonate-Z may have a high wear resistance. These binder resins may be used alone or in combination of two or more.

A weight ratio of the charge transporting material to the binder resin in the charge transport layer may be in a range of about 1:0.5 to about 1:2, for example, about 1:0.5 to about 1:1.6. When the weight ratio of the binder resin is less than about 0.5, stability of a coating composition for forming a charge transport layer may decrease due to insufficient dispersion of the charge transporting material and adhesion and mechanical strength of the charge transport layer may decrease. When the weight ratio of the binder resin is greater than about 2, sensitivity may be insufficient due to insufficient charge transporting ability and residual potential tends to increase.

A solvent used in preparation of a coating composition for forming a charge transport layer may vary according to a type of the used binder resin, and may preferably be selected in such a way that it does not affect the charge generation layer formed underneath. Examples of the solvent may be, for example, aromatic hydrocarbons such as benzene, xylene, ligroin, monochlorobenzene, and dichlorobenzene; ketones such as acetone, methyl ethyl ketone, and cyclohexanone; alcohols such as methanol, ethanol, and isopropanol; esters such as ethyl acetate and methyl cellosolve; halogenated aliphatic hydrocarbons such as carbon tetrachloride, chloroform, dichloromethane, dichloroethane, and trichloroethylene; ethers such as tetrahydrofuran (THF), dioxane, dioxolan, ethylene glycol, and monomethyl ether; amides such as N,N-dimethyl formamide, N,N-dimethyl acetamide; and sulfoxides such as dimethyl sulfoxide. The foregoing solvents may be used alone or in combination of one or two.

Next, a method of forming a charge transport layer will be described. First, about 100 parts by weight of a charge transporting material and about 50 to 200 parts by weight, for example, about 100 to 160 parts by weight of a binder resin are mixed. A solvent is mixed with the foregoing mixture so as to obtain a solid content range of about 10 wt % to 30 wt %, for example, about 15 wt % to 25 wt %. The coating composition for forming a charge transport layer may further include an additive. The additives, such as an antioxidant, an antioxidant, a dispersant, a photostabilizer, an antifoaming agent, a surfactant, a plasticizer, and an oil, may be used alone or appropriately used in combination. The coating slurry for forming a charge transport layer may include a phosphate-based compound, a phosphine oxide-based compound, and a silicone oil in order to improve wear resistance and provide lubricating characteristics (slip property) to a charge transport layer surface.

The coating composition for forming a charge transport layer thus prepared is coated on the charge generation layer. The foregoing coating methods, such as a dip coating method, a ring coating method, a roll coating method, and a spray coating method, may also be used. The substrate coated with the charge transport layer may be dried at a temperature range of about 90 to about 200° C. for about 0.1 hours to 2 hours to form the charge transport layer.

A thickness of the charge transport layer may be in a range of about 5 μm to about 50 μm, for example, about 10 μm to about 40 μm, for example, greater than about 18 μm and equal to or less than about 40 μm, or about 20 μm or more and about 36 μm or less, and for example, may be about 22 μm or more and about 34 μm or less. When the thickness of the charge transport layer is less than about 5 μm, durability may be insufficient because the thickness thereof is too small and charge characteristics may degrade, and when the thickness of the charge generation layer is greater than about 50 μm, durability may increase but a response rate tends to decrease and image quality tend to deteriorate. A total thickness of the charge generation layer and the charge transport layer may be generally set in a range of about 5 μm to about 50 μm.

Also, the electrophotographic photoreceptor of the disclosure may further include a surface protective layer on the charge transport layer, if necessary.

The electrophotographic photoreceptor according to an example of the disclosure prepared as described above may be adjusted such that an electrostatic capacitance per unit area of the electrophotographic photoreceptor is 90 pF/cm² or more, when an allowable range of the charging voltage Vₓ (unit: V) applied to the electrophotographic photoreceptor by a DC type charging device is V₀−150≤Vₓ≤V₀+150, i.e., a charging margin ΔV₀ is 150 V. Thus, an image formed by the photoreceptor exhibits no micro-jitter problem, for example, a micro-jitter occurs at an acceptable level. In this regard, V₀ represents an initial charging voltage (unit: V) applied to the electrophotographic photoreceptor by the charging device.

The electrophotographic photoreceptor according to another example of the disclosure may be adjusted such that an electrostatic capacitance per unit area of the electrophotographic photoreceptor is 80 pF/cm² or more, when an allowable range of the charging voltage Vₓ (unit: V) is V₀−100≤Vₓ≤V₀+100, i.e., a charging margin ΔV₀ is 100 V. Thus, an image formed by the photoreceptor exhibits no micro-jitter problem, for example, a micro-jitter occurs at an acceptable level.

The electrophotographic photoreceptor according to another example of the disclosure may be adjusted such that an electrostatic capacitance per unit area of the electrophotographic photoreceptor is 60 pF/cm² or more, when an allowable range of the charging voltage Vₓ (unit: V) is V₀−50≤Vₓ≤V₀+50, i.e., a charging margin ΔV₀ is 50 V. Thus, an image formed by the photoreceptor exhibits no micro-jitter problem, for example, a micro-jitter occurs at an acceptable level.

The charging device according to an example of the disclosure may apply a DC voltage to the photoreceptor in contact with the photoreceptor by using a contact charging method, and the photoreceptor may be negatively charged.

The electrophotographic photoreceptor according to an example of the disclosure may improve uniformity of electric charge density on the surface of the photoreceptor charged with negative charge in an electrophotographic image forming system using a DC contact charging method by adjusting an electrostatic capacitance to an appropriate value. Thus, by using the photoreceptor according to an example of the disclosure, high-quality images may be stably formed without micro-jitter defects for a long time.

The electrophotographic photoreceptor according to the disclosure may be incorporated into an electrophotographic cartridge or an electrophotographic image forming apparatus such as a laser printer, a copying machine, and a facsimile machine.

An electrophotographic image forming apparatus according to another example of the disclosure includes the electrophotographic photoreceptor according to an example of the disclosure, a charging device charging the electrophotographic photoreceptor and in contact with the electrophotographic photoreceptor, an exposure device forming an electrostatic latent image on a surface of the electrophotographic photoreceptor, a developing device developing the electrostatic latent image to form a visible image, a transferring device transferring the visible image on an image receiving member, and a cleaning device cleaning the surface of the electrophotographic photoreceptor after the transferring.

An electrophotographic cartridge according to another example of the disclosure may integrally support an electrophotographic photoreceptor according to an example of the disclosure, and at least one device. The at least one device may include a charging device charging the electrophotographic photoreceptor in contact with the electrophotographic photoreceptor, a developing device developing an electrostatic latent image formed on the electrophotographic photoreceptor to form a visible image, and a cleaning device cleaning a surface of the electrophotographic photoreceptor after transferring, and may be attached to an electrophotographic image forming apparatus and detachable from the electrophotographic image forming apparatus.

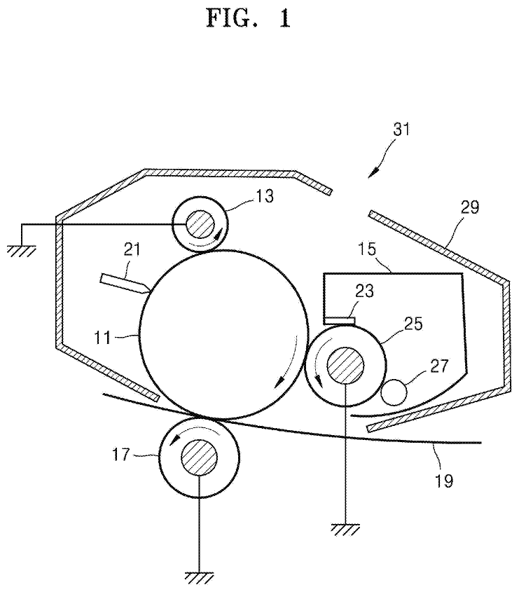

FIG. 1 is a schematic view illustrating an example of an electrophotographic image forming apparatus and an electrophotographic cartridge including an electrophotographic photoreceptor according to an example of the disclosure.

Referring to FIG. 1, an electrophotographic photoreceptor drum 11 is charged with a DC voltage by a charging roller 13 which is a charging device disposed in contact with the electrophotographic photoreceptor drum 11. Next, an electrostatic latent image is formed on the electrophotographic photoreceptor drum 11 by exposing an image portion with a laser beam. The electrostatic latent image is developed to a visible image, for example, a toner image, by a developing device 15, and the toner image is then transferred to an image receiving member 19 by a transferring roller 17 with a voltage applied. Toner remaining on a surface of the electrophotographic photoreceptor drum 11 after transferring the image is cleaned by a cleaning device, e.g., a cleaning blade 21. Subsequently, the electrophotographic photoreceptor drum 11 may be used again for forming an image. The developing device 15 includes a regulating blade 23, a developing roller 25, and/or a feeding roller 27.

An electrophotographic cartridge 29 may integrally support the electrophotographic photoreceptor drum 11, and if necessary, the charging device 13, the developing device 15, and the cleaning device 21, may be attached to an electrophotographic image forming apparatus 31, and may also be detached from the electrophotographic image forming apparatus 31.

Hereinafter, the disclosure will be described with reference to examples. However, the following examples are merely presented to explain the disclosure, and the scope of the disclosure is not limited thereto.

### Examples 1 to 9 and Comparative Examples 1 to 6: Preparation of Organic Photoreceptor Drum

(1) Preparation of Coating Composition for Undercoat Layer (UCL)

4 kg of zirconium dioxide balls with an average particle diameter of 2 mm was added to a mixed solvent of 320 g of methanol and 80 g of n-propanol, and then 141 g of titanium dioxide particles (product name: TTO-55N, manufactured by Ishihara Corporation, having average primary particle diameter of about 35 nm) was added thereto, followed by ball milling for 16 hours. 400 g of the mixed solvent was additionally added to the obtained dispersion to disperse titanium dioxide particles. This solution is referred to as ‘Solution 1’. 90 g of a Nylon resin (product name: CM8000, Toray Industries, Inc.) was dissolved in a mixed solvent of 450 g of methanol and 110 g of n-propanol. This solution is referred to as ‘Solution 2’. Solutions 1 and 2 were mixed, filtered, and ultrasonicated to prepare a coating composition for forming a UCL.

(2) Preparation of Coating Composition For Charge Generation Layer (CGL)

A mixture of y-type oxytitanyl phthalocyanine (CGM A) and α-type oxytitanyl phthalocyanine (CGM B) was used as a charge generating material (CGM). A polyvinylbutylal (PVB) resin (product name: BX-5, manufactured by Sekisui Chemical Co., Ltd.) was used as a binder of the CGM. A mixing weight ratio thereof was 40(CGM A):27(CGM B):33(PVB).

97 g of a mixed solvent of methyl alcohol and propyl alcohol (in a mixing weight ratio of 3:1) was added to the mixture and an average particle diameter of the CGM pigment particles was reduced to about 0.3 μm or less by repeating a ball milling process, thereby preparing a coating composition for forming a CGL. The prepared coating composition was stored in a refrigerator at a temperature below 5° C.

(3) Preparation of Coating Composition for Charge Transport Layer (CTL)

33 g of a charge transporting material (CTM) and 67 g of a binder were dissolved in 400 g of a mixed solvent of tetrahydrofuran (THF) and toluene (in a mixing weight ratio of 3:1) to prepare a composition for forming a CTL. The prepared composition was stored at room temperature. N,N,N,N-tetraphenylphenylbenzidine (product name: CT-100T, IT-Chem Co., Ltd., referred to as ‘CTM-A’) or a stilbene-based CTM (product name: T-405, manufactured by Takasago International Corporation, referred to as ‘CTM-B’) was used as the charge transporting material. A polycarbonate Z resin (product name: TS-2050, manufactured by Takin Ltd., referred to as tinder-A) or a silicone-containing bisphenol A-type polycarbonate copolymer (product name: EH503, manufactured by Idemitsu Kosan Co., Ltd., referred to as ‘binder-B’) was used as the binder. The composition for forming a CTL further included about 2 wt % or less of each of a silicone oil (KF-50, manufactured by Shinetsu Chemical Co., Ltd.) and an antioxidant (Irganox 1035, manufactured by BASF), and 0.025 g of a fluorine-based graft polymer GF-400 (Aron GF-400, manufactured by Toagosei).

The obtained composition was subjected to dispersion three times by using a wet dispersing apparatus (Microfludizer M-110P) at a pressure of 1500 bar to prepare a coating composition for forming a CTL.

In the cases of Comparative Example 3 (abbreviated as ‘CE 3’) and Examples 5 and 6 (abbreviated as ‘E 5’ and ‘E 6’), 0.5 wt %, 1.0 wt %, and 1.50 wt % of polytetrafluoroethylene (PTFE) filler particles (product name: Polyflon PTFE Low Polymer L-2, manufactured by Dakin Industries, having average primary particle diameter: about 200 nm to 300 nm) were further added to the compositions for forming a CTL to adjust hardness and roughness of the CTL (based on 33 g of CTM+67 g of binder=100 g), respectively.

(4) Coating Process

The coating composition for forming a UCL was applied, by dip coating, to an aluminum pipe, with or without an anodic oxide layer formed thereon and having an external diameter of 30 mm and a length of 340 mm, and dried in an oven at about 120° C. for about 30 minutes to form an UCL having a thickness of about 1.1 μm to about 2.2 μm. When the aluminum pipe had the anodic oxide layer, a thickness of the anodic oxide layer was about 4.8 μm to about 7.4 μm.

Then, the coating composition for forming a CGL was applied to the UCL by dip coating and dried in an oven at about 120° C. for about 10 minutes to form a CGL having a thickness of about 0.25 μm.

Finally, the coating composition for forming a CTL was applied to the CGL by dip coating and dried in an oven at about 120° C. for about 1 hour to form a CTL having a thickness of about 17 μm to about 40 μm.

Table 1 below shows compositions of CTLs, as surface layers of the electrophotographic photoreceptor drums prepared according to Examples 1 to 3 and Comparative Examples 1 to 6 and evaluation results of samples obtained from the CTLs.

### Reference Examples 1 to 3: Inorganic Photoreceptor

The reference examples are performed to confirm that a thickness of the CTL is not the single factor affecting a charging margin. That is, photoreceptor drums, in which a CTL formed of a-Si is coated on an anodic aluminum pipe having an external diameter of 30 mm and a length of 340 mm, were purchased from Kyocera and evaluated for comparison. The thicknesses of the a-Si CTLs of the photoreceptor drums according to Reference Examples 1 to 3 were about 20 μm, about 25 μm, and about 30 μm, respectively.

Table 1 shows compositions of the photoreceptor drums prepared according to Examples 1 to 10, Comparative Examples 1 to 5, and Reference Examples 1 to 3.

TABLE 1

| | Name of | Thickness | | | | | | |
|---|---|---|---|---|---|---|---|---|
| | photo- | of anodic | Thick- | Thick- | Composition of CTL | | | |
| | receptor | oxide | ness of | ness of | Thick- | Type | Type | Presence |
| | drum | layer | UCL | CGL | ness | of | of | of PTFE |
| | sample | (μm) | (μm) | (μm) | (μm) | CTM | binder | filler |
| CE 1* | A-39 | 0 | 1.8 | 0.25 | 40 | CTM-A | binder-A | No |
| E 1 | A-28 | 0 | 1.8 | 0.25 | 29 | CTM-A | binder-A | No |
| E 2 | A-17 | 0 | 1.8 | 0.25 | 17 | CTM-A | binder-A | No |
| CE 2 | B-39 | 6.9 | 2.2 | 0.25 | 39 | CTM-A | binder-A | No |
| E 3 | B-28 | 7.1 | 2.1 | 0.25 | 28 | CTM-A | binder-A | No |
| E 4 | B-17 | 7.0 | 2.0 | 0.25 | 17 | CTM-A | binder-A | No |
| CE 3 | C-39 | 6.7 | 1.7 | 0.25 | 40 | CTM-B | binder-A | Yes |
| E 5 | C-28 | 7.2 | 1.8 | 0.25 | 29 | CTM-B | binder-A | Yes |
| E 6 | C-17 | 7.2 | 1.8 | 0.25 | 18 | CTM-B | binder-A | Yes |
| CE 4 | D-39 | 7.4 | 2.0 | 0.25 | 39 | CTM-B | binder-A | No |
| E 7 | D-28 | 5.9 | 1.9 | 0.25 | 30 | CTM-B | binder-A | No |
| E 8 | D-17 | 7.1 | 1.7 | 0.25 | 17 | CTM-B | binder-A | No |
| CE 5 | E-39 | 4.8 | 1.1 | 0.25 | 39 | CTM-A | binder-B | No |
| E 9 | E-28 | 5.2 | 1.2 | 0.25 | 29 | CTM-A | binder-B | No |
| E 10 | E-17 | 5.2 | 1.1 | 0.25 | 17 | CTM-A | binder-B | No |
| RE 1 | F-30 | 0 | 0 | 0 | 30 | — | — | — |
| RE 2 | F-25 | 0 | 0 | 0 | 25 | — | — | — |
| RE 3 | F-20 | 0 | 0 | 0 | 20 | — | — | — |

*CE: Comparative Example, E: Example, RE: Reference Example

For the photoreceptor drums prepared according to Examples 1 to 10, Comparative Examples 1 to 5, and Reference Examples 1 to 3, correlation between electrostatic capacitance of each photoreceptor and micro-jitter were investigated in the following manner.

Evaluation Method

<Measurement of Electrostatic Capacitance>

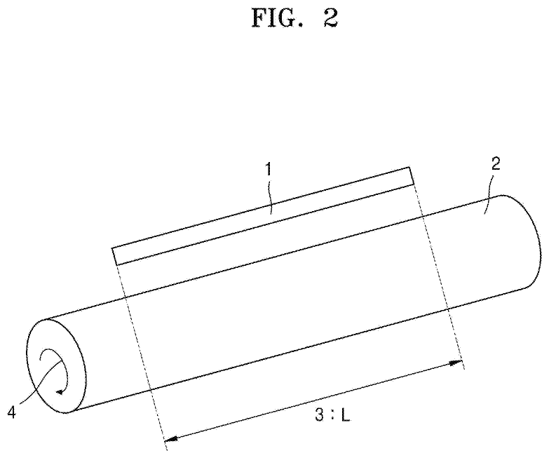

Electrostatic capacitance of the photoreceptor drums prepared according to Examples 1 to 10, Comparative Examples 1 to 5, and Reference Examples 1 to 3 was measured using a self-made jig schematically shown in FIG. 2 in an environment of a temperature of 23° C. and a relative humidity of 50% as follows.

When a scorotron 1 charges a photoreceptor 2, a charging width L, which is a width of a surface of the photoreceptor 2 to be charged, is indicated by an arrow 3. The photoreceptor 2 was rotated 4 at a surface speed of v. Based thereon, a charged area S of the photoreceptor 2 satisfies Equation 1 below.

S=v×t×L (1)

Here, S is a charged area of the surface of the photoreceptor drum 2, t is a charging time, v is a circumferential speed when the surface of the photoreceptor drum 2 rotates, and L is a charging width of the surface of the photoreceptor drum 2.

When an electric potential difference between two electrodes is V in the case where an amount of electric charge Q is given between the two electrodes, the correlation among the electrostatic capacitance C, the amount of electric charge Q between the two electrodes, and the electric potential difference V satisfies Equation 2 below.

Q=C×V (2)

In the case of a planar capacitor model, the electrostatic capacitance C may be represented by Equation 3 below.

C=ε×S/D=ε₀×εᵣ×S/D (3)

Here, D is a distance between two electrodes, Lo is permittivity of vacuum, i.e., 8.854×10⁻¹² (F/m), L is permittivity of a material used, Eᵣ is a relative permittivity of the material used, and S is an area of charged area.

Equation 4 below is established by putting Equations 1 and 3 into Equation 2.

Q=ε₀×εᵣ×v×t×L×V/D (4)

Equations 5 and 6 below are established by differentiating Equation 4 with respect to the charging time t.

dQ/dt=I=ε₀×εᵣ×v×L×V/D (5)

εᵣ=(I×D)/(ε₀×v×L×V) (6)

Here, I is current. The electrostatic capacitance C may be obtained by putting Equation 6 into Equation 3.

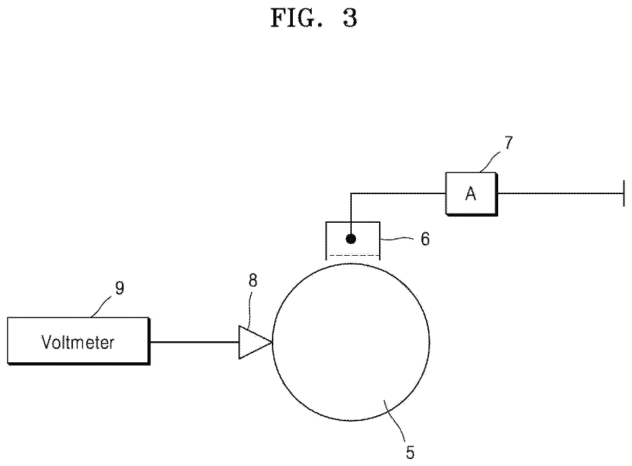

FIG. 3 is a schematic circuit diagram for measuring current I and charging potential V for measuring the electrostatic capacitance of the photoreceptor drum. Referring to FIG. 3, the surface of the photoreceptor drum 5 is charged to −600 V by using a scorotron charging device 6 as a potential meter. In this case, through a potential probe 8, charging potential V of the surface of the photoreceptor drum 5 was measured using a potential meter 9 and current I supplied to the scorotron charging device 6 was measured using a current meter 7.

<Measurement of Thickness of Layer>

Thicknesses of the UCL, the CGL, and the CTL shown in Table 1 were measured by using an eddy current measurement method, which may be used for measuring organic thin films. A DUALSCOPE® FMP40 manufactured by Fisher was used as a measurement device. The thickness of each layer shown in Table 1 is an average of thicknesses measured at three points of central and left and right portions of each layer. In order to reduce measurement errors, the same pressure was applied to each layer using a jig driven by a motor.

<Evaluation of Micro-Jitter>

The electrophotographic photoreceptor drums obtained in Examples 1 to 10, Comparative Examples 1 to 5, and Reference Examples 1 to 3 were mounted in a laser printer (Samsung Electronics Co., Ltd. Model: MultiXpress SL-X7600) operating in a DC method, and micro-jitter levels were evaluated by using the following method for halftone pattern images (a width of about 18 cm and a length of about 25 cm) printed in an environment of a temperature of 23° C. and a relative humidity of 50%. A charging roller applied to the printer is designed to exhibit effective charging performance at a low temperature and a high temperature. That is, the charging roller is a cylindrical roller formed of epichlorohydrin on which a Nylon resin is coated and having a volume resistance of 2.0×10⁺⁵Ω and a surface resistance of 1.0×10⁺⁸Ω. Basic physical properties of the charging roller are shown in Table 2.

TABLE 2

| | | Surface roughness (μm) | | |
|---|---|---|---|---|
| | Angle | Ra* | Rz | Rsm |
| Charging | 0° | 3.07 | 10.96 | 98.80 |
| roller | 90° | 2.99 | 9.30 | 89.65 |
| | 180° | 2.94 | 8.30 | 83.01 |
| | 270° | 3.05 | 8.53 | 93.68 |

In Table 2, Ra* is an arithmetical mean roughness, Rz is a ten-point mean roughness, and Rsm is a mean width of profile elements.

The degrees of micro-jitter occurrence were compared by actually printing images. The charging roller of the laser printer charges the photoreceptor drum under the following conditions.

Charging method: DC contact charging method

Applied charging voltage: −1,250 V

External diameter of photoreceptor drum: 30 mm.

Levels of micro-jitter occurrence were compared using the charging potential as a variable by using the MultiXpress SL-X7600 laser printer. The printer operated at a printing speed of 60 ppm. A range of charging potential, i.e., a charging margin was determined, in which an acceptable or tolerable level of micro-jitter occurs in images, while changing the charging potential using a target initial surface potential V₀ of −600 V applied to the photoreceptor drum as a reference value. It is determined that the greater the charging margin ΔV₀ is, the smaller the micro-jitter problem is. It was determined that the charging margin ΔV₀ of 100 V or more was a good level, and the charging margin was limited up to 250 V due to an evaluation limit. For example, the charging margin ΔV₀ of 100 V means that the photoreceptor may be charged with no micro-jitter problem, in other words micro-jitter occurs at an acceptable level, in a charging potential range of −700 V to −500 V.

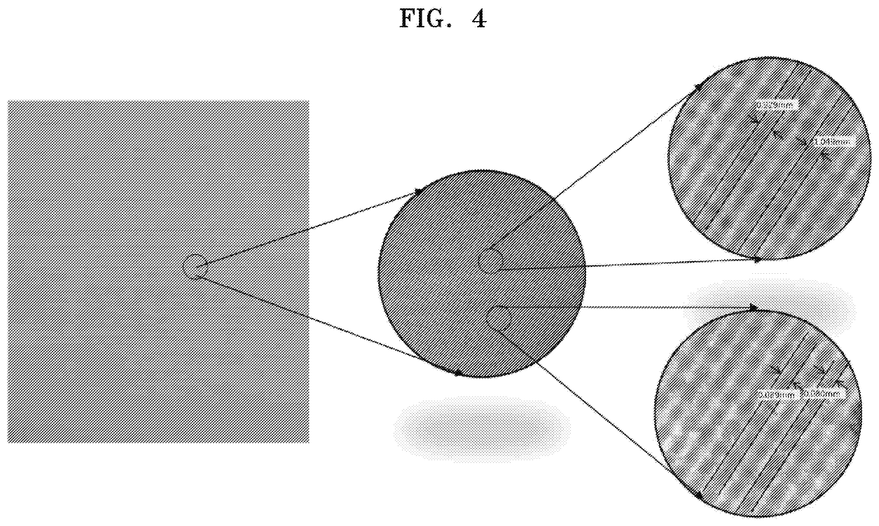

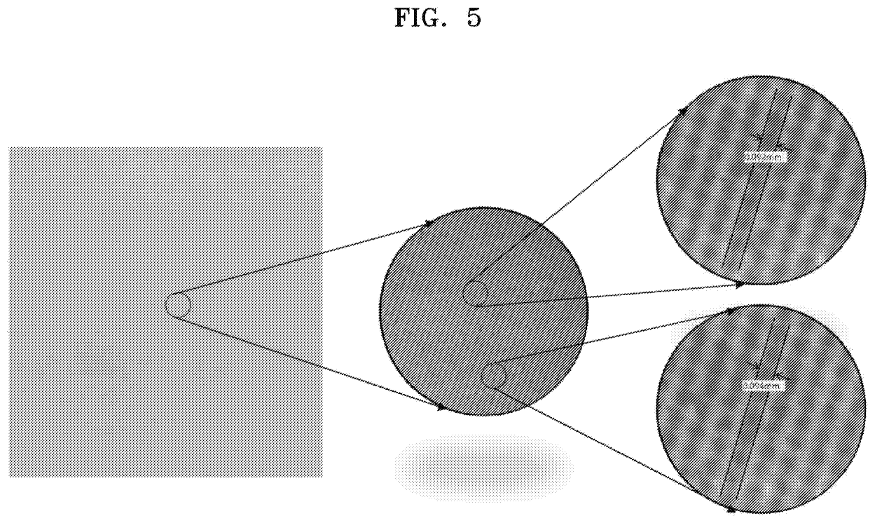

FIGS. 4 and 5 are photographs showing a case in which a micro-jitter problem occurs (Comparative Example 1) and a case in which a micro-jitter problem does not occur (Example 1), respectively when black halftone images are printed by using the MultiXpress SL-X7600 laser printer. Referring to FIG. 4, it was confirmed that a micro-jitter image defect problem occurred because the photoreceptor was not uniformly charged. For example, a stripe of dark color dots and a stripe of light color dots are observed when the printed image is magnified under a microscope. As shown in FIG. 4, widths of the stripe of dark color dots were 0.929 mm, 1.049 mm, 0.089 mm, and 0.080 mm considerably varying according to positions of the printed image, indicating that a micro-jitter problem occurred. The micro-jitter problem may be understood that non-uniform charging potential of the photoreceptor affects an exposure potential in the same manner, causing formation of a non-uniform toner image. FIG. 5 is an image that may be seen in a normal case when the photoreceptor is uniformly charged. Referring to FIG. 5, widths of the stripe of dark color dots were 0.092 mm and 0.094 mm slightly varying according to positions of the printed image, indicating that a micro-jitter problem did not occur.

Table 3 shows evaluation results of the photoreceptor drums obtained according to Examples 1 to 10, Comparative Examples 1 to 5, and Reference Examples 1 to 3. In this regard, the charging potential applied during tests varied by a unit of 50 V.

TABLE 3

| | Name of | Electrostatic | Charging | Evaluation results |
|---|---|---|---|---|
| | photoreceptor | capacitance | margin | (satisfying ΔV₀ ≥ |
| | drum sample | (pF/cm²) | (ΔV₀) | 100?) |
| CE 1 | A-39 | 59.3 | −50 | No |
| E 1 | A-28 | 82.5 | −200 | Yes |
| E 2 | A-17 | 138.5 | −250 | Yes |
| CE 2 | B-39 | 60.4 | −50 | No |
| E 3 | B-28 | 84.9 | −200 | Yes |
| E 4 | B-17 | 146.9 | −250 | Yes |
| CE 3 | C-39 | 59.2 | −50 | No |
| E 5 | C-28 | 78.3 | −150 | Yes |
| E 6 | C-17 | 125.7 | −200 | Yes |
| CE 4 | D-39 | 61.3 | −50 | No |
| E 7 | D-28 | 83.4 | −100 | Yes |
| E 8 | D-17 | 138.6 | −200 | Yes |
| CE 5 | E-39 | 65.2 | −50 | No |
| E 9 | E-28 | 87.5 | −100 | Yes |
| E 10 | E-17 | 150.5 | −250 | Yes |
| RE 1 | F-30 | 660 | −250 | Yes |
| RE 2 | F-25 | 752 | −250 | Yes |
| RE 3 | F-20 | 1003 | −250 | Yes |

Referring to Table 3, a difference between A-series photoreceptor samples and B-series photoreceptor samples is the presence or absence of the anodic oxide layer, and it may be confirmed that there is no significant difference in the electrostatic capacitance and the charging margin therebetween. In addition, based on comparison results between C-series photoreceptor samples and D-series photoreceptor samples, it may be confirmed that the electrostatic capacitance and the charging margin are not significantly influenced by the presence or absence of the PTFT filler, i.e., the surface state of the CTL. Based on comparison results between C-series photoreceptor samples and E-series photoreceptor samples, it may be confirmed that the electrostatic capacitance and the charging margin are not significantly influenced by chemical structures of the CTM and the binder resin contained in the CTL. However, it was confirmed that the charging margin generally increased as the thickness of the CTL decreased in the cases of A-series to the E-series photoreceptor samples that are organic photoreceptor drums. This demonstrates that the micro-jitter problem may be reduced according to the amount of electric charge used for charging. To identify this, micro-jitter problems of F-series photoreceptor samples that are inorganic photoreceptor drums were evaluated, and all of the F-series photoreceptor samples exhibited a charging margin of 250 V when the thicknesses of the a-Si CTLs were 20 μm, 25 μm, and 30 μm. The charging margin of the A-series to the E-series photoreceptor samples that are organic photoreceptor drums was about 100 V when the thickness of the CTL was 30 μm. Thus, a charging behavior of the photoreceptor according to the DC contact charging method cannot be explained based on the thickness of the CTL alone and it may be confirmed that the electrostatic capacitance of the photoreceptor is an effective parameter to control the micro-jitter.

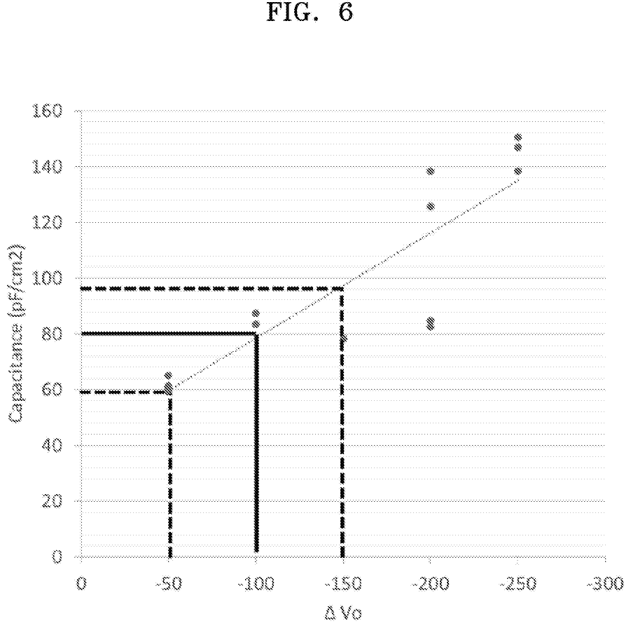

FIG. 6 is a graph showing results of plotting electrostatic capacitance values and charging margin values ΔV₀ of the photoreceptor drums obtained in Examples 1 to 10, Comparative Examples 1 to 5, and Reference Examples 1 to 3 on the Y-axis and the X-axis, respectively. Referring to FIG. 6, it may be confirmed that the charging margin generally increases as the electrostatic capacitance increases. This correlation may be applied to the inorganic photoreceptor drums (F-series samples) in the same manner. Also, referring to the F-series samples, even the F-30 sample having a thickness of 30 μm exhibited a good micro-jitter level, and therefore it may be confirmed the electrostatic capacitance which determines the amount of electric charge to charge the photoreceptor is a factor for controlling micro-jitter. In this regard, a charging margin ΔV₀ of 100 V or more is determined as a good micro-jitter level, and thus it was confirmed that an electrostatic capacitance value of 80 pF/cm² or more is needed.

Based on the above results, it may be confirmed that the photoreceptor according to the disclosure may improve uniformity of electric charge density on the surface of the photoreceptor in an electrophotographic image forming system. Therefore, high-quality images may be stably formed without a micro-jitter problem for a long time by using the photoreceptor.

It should be understood that examples described herein should be considered in a descriptive sense and should not be limiting. Descriptions of features within each example should be considered as available for other similar features in other examples. While examples have been described with reference to the drawings, it will be understood that various changes in form and details may be made therein without departing from the spirit and scope as defined by the following claims.

What is claimed is:

1. An electrophotographic photoreceptor, comprising:
an electrically conductive substrate; and
a photosensitive layer formed on the electrically conductive substrate, the photosensitive layer including a charge generation layer and a charge transport layer, and
when an allowable range of a charging voltage Vₓ, in volts, applied to the electrophotographic photoreceptor by a charging device is V₀−150≤VₓV₀+150, an electrostatic capacitance per unit area of the electrophotographic photoreceptor is 90 pF/cm² or more, V₀ being an initial charging voltage in volts applied to the electrophotographic photoreceptor by the charging device.

2. The electrophotographic photoreceptor of claim 1, wherein when the allowable range of the charging voltage Vₓ is V₀−100≤Vₓ≤V₀+100, the electrostatic capacitance per unit area of the electrophotographic photoreceptor is 80 pF/cm² or more.

3. The electrophotographic photoreceptor of claim 1, wherein when the allowable range of the charging voltage Vₓ is V₀−50≤Vₓ≤V₀+50, the electrostatic capacitance per unit area of the electrophotographic photoreceptor is 60 pF/cm² or more.

4. The electrophotographic photoreceptor of claim 1, further comprising an undercoat layer disposed between the electrically conductive substrate and the photosensitive layer.

5. The electrophotographic photoreceptor of claim 1, wherein the electrophotographic photoreceptor is to receive a direct current voltage from the charging device via a contact charging method, while the electrophotographic photoreceptor is in contact with the charging device.

6. The electrophotographic photoreceptor of claim 5, wherein the electrophotographic photoreceptor is negatively charged.

7. The electrophotographic photoreceptor of claim 1, wherein the charging device is a conductive rubber charging roller.

8. An electrophotographic cartridge comprising the electrophotographic photoreceptor according to claim 1.

9. An electrophotographic image forming apparatus comprising the electrophotographic photoreceptor according to claim 1.
